(19) United States
(12) Patent Application Publication
(10) Pub. No.: US 2025/0374306 A1
(43) Pub. Date: Dec. 4, 2025

(54) Co-Channel Coexistence of Multiple Sidelink Radio Access Technologies

(71) Applicant: Apple Inc., Cupertino, CA (US)

(72) Inventors: Zhibin Wu, Los Altos, CA (US); Chunxuan Ye, San Diego, CA (US); Peng Cheng, Beijing (CN); Alexander Sirotkin, Hod HaSharon (IL); Haijing Hu, Los Gatos, CA (US)

(21) Appl. No.: 18/861,099

(22) PCT Filed: Apr. 29, 2022
(86) PCT No.: PCT/CN2022/090215

§ 371 Date: Oct. 28, 2024

(51) Int. Cl. H04W 72/40; H04W 72/12

(52) U.S. Cl. CPC H04W 72/40; H04W 72/1215

(57) ABSTRACT

Techniques for co-channel coexistence of multiple sidelink radio access technologies. The technique including receiving, by a first wireless device, sidelink control information (SCI) of a first sidelink transmission from a second wireless device over a first radio access technology (RAT), the SCI indicating a set of resources used by the first RAT; determining, based on the received sidelink transmission, a set of candidate resources for a second RAT from a sidelink resources pool for the second RAT, the second RAT different from the first RAT; and transmitting a second sidelink transmission to a third wireless device using a candidate resource selected from the set of candidate resources for the second RAT.

### FIELD

The present application relates to wireless devices and wireless networks including devices, computer-readable media, and methods for enhancing sidelink sensing and resource allocation.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1xRTT, 1xEV-DO, HRPD, eHRPD), IEEE 802.11 (WLAN or Wi-Fi), BLUETOOTH™, etc.

The ever increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including fifth generation (5G) new radio (NR) communication. Accordingly, improvements in the field in support of such development and design are desired.

### SUMMARY

Aspects relate to devices, computer-readable media, and methods for co-channel coexistence of multiple sidelink first radio access technologies (RATs). These aspects include receiving, by a first wireless device, sidelink control information (SCI) of a first sidelink transmission from a second wireless device over a RAT, the SCI indicating a set of resources used by the first RAT. These aspects also include determining, based on the received sidelink transmission, a set of candidate resources for a second RAT from a sidelink resources pool for the second RAT, the second RAT different from the first RAT. These aspects also include transmitting a second sidelink transmission to a third wireless device using a candidate resource selected from the set of candidate resources for the second RAT.

Another aspect relates to a technique for wireless communications, such as for co-channel coexistence of multiple sidelink RATs. The technique includes receiving, by a first wireless device, the sidelink control information (SCI) of a first sidelink transmission from a second wireless device over a first RAT, the first sidelink transmission indicating a set of resources used by the first RAT. The technique also includes transmitting an indication of the set of resources used by the first RAT to a base station. The technique further includes receiving a set of resources for a second RAT from a sidelink resources pool for the second RAT, the second RAT different from the first RAT. The technique also includes transmitting a second sidelink transmission to a third wireless device using a resource from the set of resources for the second RAT.

Another aspect relates to a wireless device. The wireless device includes a radio and a processor operably coupled to the radio. The processor is configured to receive sidelink control information (SCI) of a first sidelink transmission from a second wireless device over a first RAT, the SCI indicating a set of resources used by the first RAT. The processor is also configured to determine, based on the received sidelink transmission, a set of candidate resources for a second RAT from a sidelink resources pool for the second RAT, the second RAT different from the first RAT. The processor is further also configured to transmit a second sidelink transmission to a third wireless device using a candidate resource selected from the set of candidate resources for the second RAT.

Another aspect relates to a wireless device. The wireless device includes a radio and a processor operably coupled to the radio. The processor is configured to receive the sidelink control information (SCI) of a first sidelink transmission from a second wireless device over a first RAT, the first sidelink transmission indicating a set of resources used by the first RAT. The processor is also configured to transmit an indication of the set of resources used by the first RAT to a base station. The processor is further configured to receive a set of resources for a second RAT from a sidelink resources pool for the second RAT, the second RAT different from the first RAT. The processor is also configured to transmit a second sidelink transmission to a third wireless device using a resource from the set of resources for the second RAT.

The techniques described herein may be implemented in and/or used with a number of different types of devices, including but not limited to cellular phones, wireless devices, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter can be obtained when the following detailed description of various aspects is considered in conjunction with the following drawings.

FIG. 1 illustrates an example wireless communication system, according to some aspects.

FIG. 2 illustrates a base station (BS) in communication with a user equipment (UE) device, according to some aspects.

FIG. 3 illustrates an example block diagram of a UE, according to some aspects.

FIG. 4 illustrates an example block diagram of a BS, according to some aspects.

FIG. 5 illustrates an example block diagram of cellular communication circuitry, according to some aspects.

FIG. 6 is a timing diagram illustrating partial sensing, in accordance with aspects of the present disclosure.

FIG. 7 illustrates a wireless sidelink communications system with multiple sidelink RAT coexistence, in accordance with aspects of the present disclosure.

FIG. 8 is a conceptual resource diagram illustrating a comparison of sidelink subchannel sizes in a frequency domain, in accordance with aspects of the present disclosure.

FIGS. 9-13 illustrate wireless sidelink communications systems with multiple sidelink RAT coexistence, in accordance with aspects of the present disclosure

FIG. 14 is a flow diagram illustrating a technique for wireless sidelink communications, in accordance with aspects of the present disclosure.

FIG. 15 is a flow diagram illustrating a technique for wireless sidelink communications, in accordance with aspects of the present disclosure.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

In certain wireless communications systems, a wireless device may communicate directly with another wireless device without being routed through, for example, a wireless node (e.g., base station). For example, a wireless device may establish a sidelink session with another peer wireless device. Once the sidelink session is established, the wireless device may monitor for and transmit messages from the other peer wireless device and vice versa. Often sidelink communications abilities may be embedded in wireless devices which may be durable, such as cars, roads, lights, buildings, etc. Such devices may be difficult or impossible to upgrade to newer sidelink RATs are released. As an example, deployed devices with LTE sidelink may not be upgradeable to support NR sidelink. Thus, newer sidelink RATs may need to co-exist with legacy sidelink RATs. In some cases, these newer non-legacy sidelink RATs may use frequency bands which overlap with those used by legacy RATs. To help enable co-existence of multiple RATs on overlapping channels, NR sidelink procedures may be enhanced to detect and avoid wireless resources (e.g., in the time and frequency domain) being used by legacy sidelink RATs.

Generally, there are two overarching scenarios that may be supported by a wireless device capable of communicating with both a legacy sidelink RAT and a non-legacy sidelink RAT. In the first scenario, the wireless device, connected to a sidelink RAT operating in an autonomous mode, detects another, different, sidelink RAT and determines the wireless resources used by the other sidelink RAT. The wireless device may then determine which resources of those wireless resources used by the other sidelink RAT should be avoided and schedules transmissions according to those determined resources. In cases where the other sidelink RAT is controlled by a wireless node, the wireless device may use cross-RAT signaling with the wireless node to help schedule transmissions.

In the second scenario, the wireless device, connected to a sidelink RAT operating in a wireless node controlled sidelink RAT, detects another, different sidelink RAT. The wireless device may determine the wireless resources used by the other sidelink RAT and then communicates this information to the wireless node. The wireless node may then schedule the transmissions of the wireless node controlled sidelink RAT to avoid resources used by the other sidelink RAT.

The following is a glossary of terms that may be used in this disclosure: Memory Medium-Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

User Equipment (UE) (also “User Device” or “UE Device”)-any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, etc. In general, the term “UE” or “UE device” can be broadly defined to encompass any electronic, computing, and/or telecommunications device (or combination of devices) which is transportable by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “base station” or “wireless station” has the full breadth of its ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” etc., may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” etc., are not intended to limit the concepts discussed herein to any particular wireless technology and the concepts discussed may be applied in any wireless system.

### Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

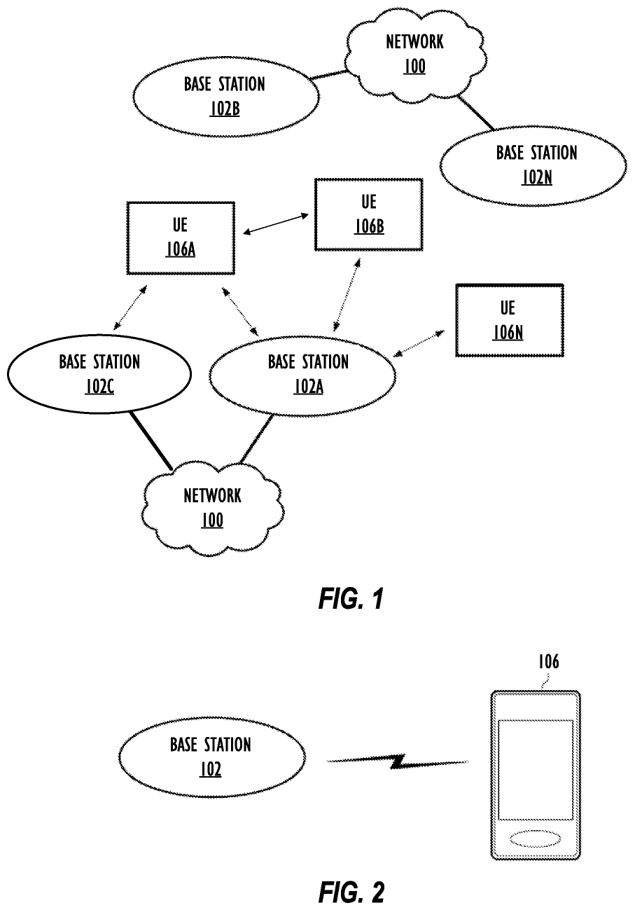

Turning now to FIG. 1, a simplified example of a wireless communication system is illustrated, according to some aspects. It is noted that the system of FIG. 1 is merely one example of a possible system, and that features of this disclosure may be implemented in any of various systems, as desired.

As shown, the example wireless communication system includes a base station 102A, which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some embodiments, the UEs 106 may be IoT UEs, which may comprise a network access layer designed for low-power IoT applications utilizing short-lived UE connections. An IoT UE can utilize technologies such as M2M or MTC for exchanging data with an MTC server or device via a public land mobile network (PLMN), proximity service (ProSe) or device-to-device (D2D) communication, sensor networks, or IoT networks. The M2M, D2D, or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using a PC5 interface for direct communications between devices. The IoT UEs may also execute background applications (e.g., keep-alive messages, status updates, etc.) to facilitate the connections of the IoT network.

As shown, the UEs 106, such as UE 106A and UE 106B, may directly exchange communication data via a PC5 interface 108. The PC5 interface 105 may comprise one or more logical channels, including but not limited to a physical sidelink shared channel (PSSCH), a physical sidelink control channel (PSCCH), a physical sidelink broadcast channel (PSBCH), and a physical sidelink feedback channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weatherproof enclosure suitable for outdoor installation, and may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some aspects, base station 102A may be a next generation base station, e.g., a 5G New Radio (5G NR) base station, or “gNB.” In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

### Example User Equipment (UE)

FIG. 2 illustrates user equipment 106 (e.g., one of the devices 106A through 106N) in communication with a base station 102, according to some aspects. The UE 106 may be a device with cellular communication capability such as a mobile phone, a hand-held device, a computer, a laptop, a tablet, a smart watch or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1xRTT, or either of LTE or GSM, among various possibilities), and separate radios for communicating using each of Wi-Fi and Bluetooth. Other configurations are also possible.

In some embodiments, a downlink resource grid can be used for downlink transmissions from any of the base stations 102 to the UEs 106, while uplink transmissions can utilize similar techniques. The grid can be a time-frequency grid, called a resource grid or time-frequency resource grid, which is the physical resource in the downlink in each slot. Such a time-frequency plane representation is a common practice for orthogonal frequency-division multiplexing (OFDM) systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher-layer signaling to the UEs 106. The physical downlink control channel (PDCCH) may carry information about the transport format and resource allocations related to the PDSCH channel, among other things. It may also inform the UEs 106 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

### Example Communication Device

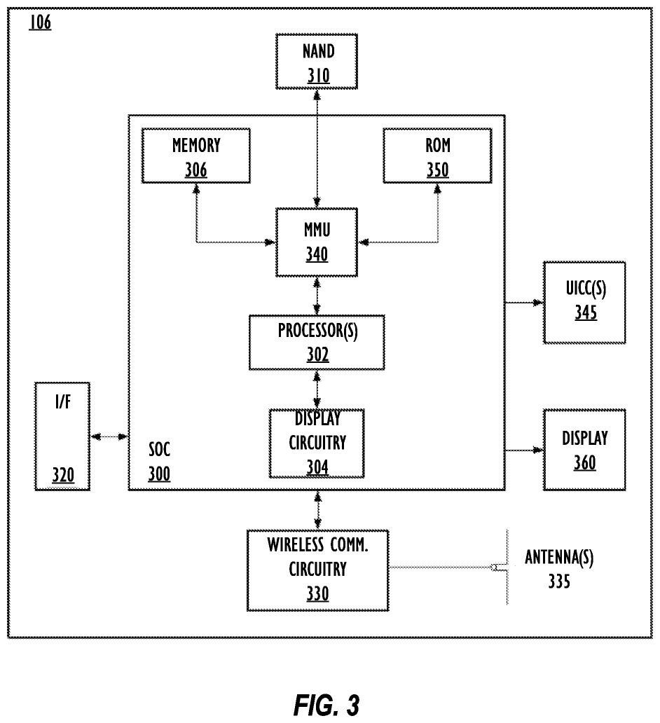

FIG. 3 illustrates an example simplified block diagram of a communication device 106, according to some aspects. It is noted that the block diagram of the communication device of FIG. 3 is only one example of a possible communication device. According to aspects, communication device 106 may be a user equipment (UE) device, a mobile device or mobile station, a wireless device or base station, a desktop computer or computing device, a mobile computing device (e.g., a laptop, notebook, or portable computing device), a tablet, and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, etc.). In some aspects, communication device 106 may include wired communication circuitry (not shown), such as a network interface card, e.g., for Ethernet.

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a multiple-input multiple output (MIMO) configuration.

In some aspects, as further described below, cellular communication circuitry 330 may include one or more receive chains (including and/or coupled to (e.g., communicatively; directly or indirectly) dedicated processors and/or radios) for multiple RATs (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with a second radio. The second radio may be dedicated to a second RAT, e.g., 5G NR, and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, etc.) configured to perform the functions of wireless communication circuitry 330.

### Example Base Station

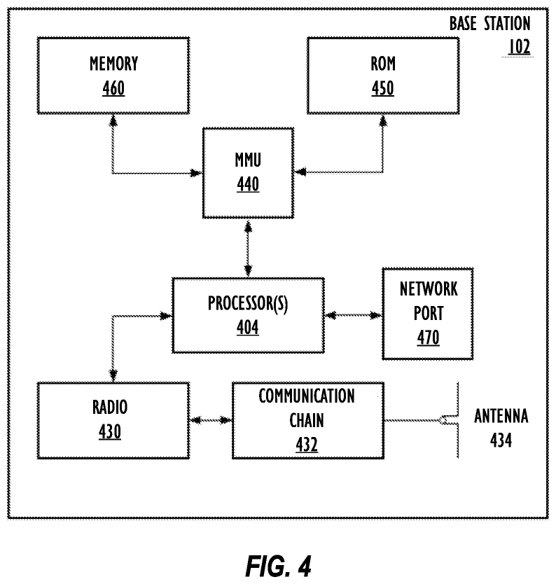

FIG. 4 illustrates an example block diagram of a base station 102, according to some aspects. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, e.g., a 5G New Radio (5G NR) base station, or “gNB.” In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mm Wave, the 5G NR radio may be coupled to one or more mm Wave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### Example Cellular Communication Circuitry

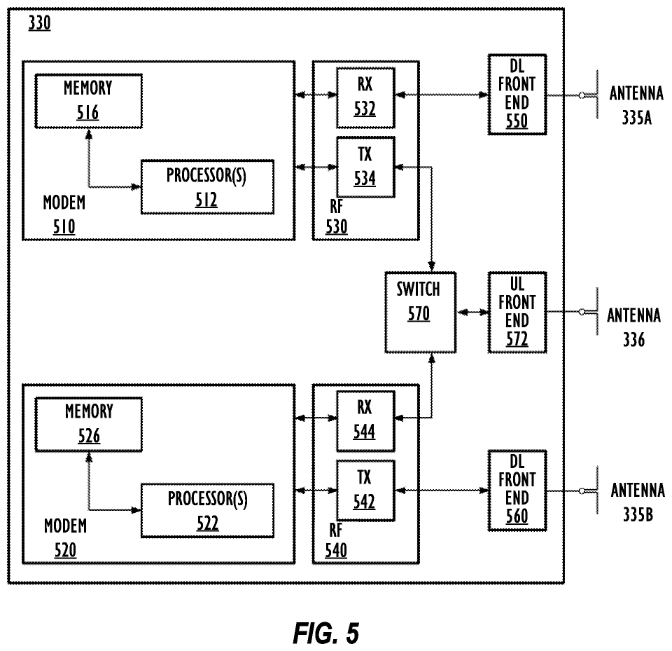

FIG. 5 illustrates an example simplified block diagram of cellular communication circuitry, according to some aspects. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some aspects, cellular communication circuitry 330 may be included in a communication device, such as communication device 106 described above. As noted above, communication device 106 may be a user equipment (UE) device, a mobile device or mobile station, a wireless device or base station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown. In some aspects, cellular communication circuitry 330 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 330 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some aspects, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some aspects, receive circuitry 542 may be in communication with DL front end 560, which may include circuitry for receiving radio signals via antenna 335b.

In some aspects, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more processing elements. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some aspects, the cellular communication circuitry 330 may include only one transmit/receive chain. For example, the cellular communication circuitry 330 may not include the modem 520, the RF front end 540, the DL front end 560, and/or the antenna 335b. As another example, the cellular communication circuitry 330 may not include the modem 510, the RF front end 530, the DL front end 550, and/or the antenna 335a. In some aspects, the cellular communication circuitry 330 may also not include the switch 570, and the RF front end 530 or the RF front end 540 may be in communication, e.g., directly, with the UL front end 572.

### Sidelink Communications

In a sidelink scenario, the wireless device is communicating directly with other wireless devices without communications having to be routed through a wireless node (e.g., base station). Sidelinks (e.g., via the PC5 interface) are the logical direct interface between wireless devices. Sidelink connections may include a collection of physical signals, physical channels, transport channels and messages that are related to UL signaling but also incorporate some concepts from DL synchronization and control signaling which helps allow a group of wireless devices to synchronize and determine how to share wireless resources in the time and frequency domains.

For sidelink connections between wireless devices, according to some implementations, a sidelink resource pool may be determined for wireless devices. The sidelink resource pool may include a set of resources, such as frequencies, subframes, slots, radio blocks, etc., for shared use by wireless devices for sidelink communications between the wireless devices. In some cases, a sidelink resource pool may be preconfigured, for example, by a manufacturer or a network operator, and multiple sidelink resource pools may be used. For example, different sidelink resource pools may be provided for based on the location of the wireless device.

Wireless devices may also have multiple sidelink operating modes by which to obtain sidelink resources from the sidelink resources pool. For example, two sidelink modes may be defined in some cases. In the first sidelink mode, a wireless network may allocate sidelink resources from the sidelink resources pool to the wireless device. As an example, LTE sidelink wireless devices operating in LTE mode 3 will obtain sidelink resources allocated by an eNB and NR sidelink wireless devices operating in NR sidelink mode 1 will obtain sidelink resources allocated by a gNB. The wireless device may obtain sidelink resource information from the wireless network, for example, via a message such as a DCI format 3_0 message from a wireless node. In this mode, the general structure of a resource pool is still configured by eNB or gNB via an RRC message, while the DCI in PDCCH will indicate the exact position of an allocated resource within a resource pool.

In the second sidelink mode, a transmitting wireless device may sense a physical medium, such as a set of radio frequencies from a sidelink resources pool, to determine a set of unused frequency resources, and select the sidelink resource from the set of unused frequency resources without involving a base station, such as an eNB or gNB. As an example, LTE sidelink wireless device operating in LTE mode 4 will sense the wireless medium based on a configured (and/or preconfigured) sidelink resources pool to determine a set of candidate resources that may be used for LTE sidelink communications (e.g., LTE-V2X). Similarly, an NR sidelink wireless device operating in NR sidelink mode 2 will also sense the wireless medium based on a configured (and/or preconfigured) sidelink resources pool to determine a set of candidate resources that may be used for NR sidelink communications. In the second sidelink mode, the sidelink resources pool may be predefined, for example, by a standard, network operator, and/or manufacturer, and may be based on a location, region, country, time, etc. A set of rules may be defined for how the frequency resources may be selected and the frequency resources may vary based on a location of the wireless device. In the second sidelink mode, one or more of the wireless devices may be either connected, not connected, or outside of a wireless network coverage area.

### Sidelink Sensing

A wireless device in sidelink operation may monitor resources of the sidelink resource pool. In some cases, from the reception point of view, a wireless device may monitor all possible resources from the sidelink resource pool. The continual monitoring may not be desirable for power efficiency. In order to reduce the power consumption used to monitor the sidelink resource pool, the UE may selectively monitor resources. As one example, the wireless device may monitor resources of the sidelink resources pool prior to transmitting a message to determine when the wireless device may be able to transmit the message without interfering with another transmission. Other wireless devices may reserve a future transmission resource (e.g., reserve a later slot to transmit on) at various intervals.

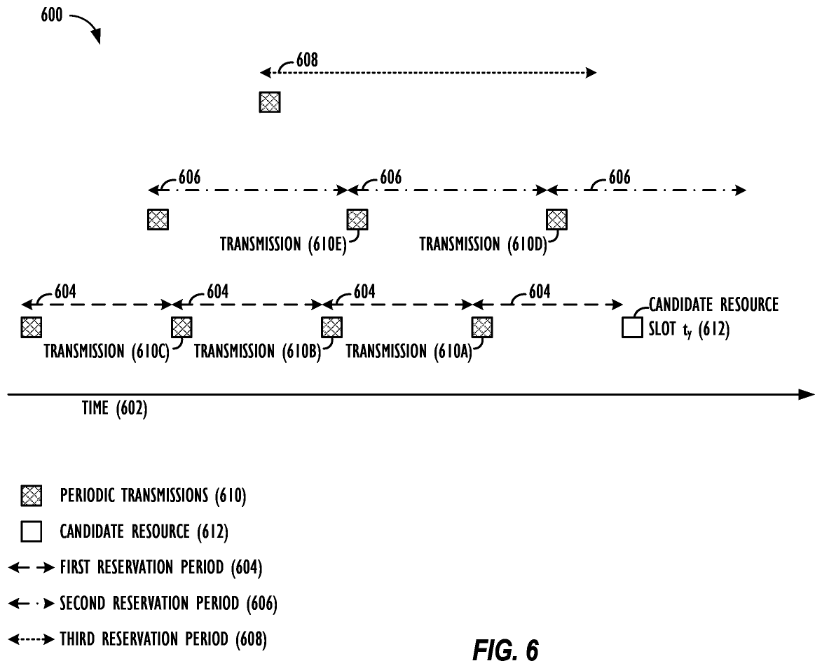

FIG. 6 is a timing diagram 600 illustrating partial sensing, in accordance with aspects of the present disclosure. Timing diagram 600 illustrates periodic transmissions plotted on a time axis 602. In some cases, wireless devices operating in a sidelink mode may periodically transmit information. For example, a V2X device may be configured to periodically transmit traffic data at set intervals using resources from the sidelink resources pool. These wireless devices may be configured to periodically transmit based on a reservation period, which is a defined time interval between certain transmissions. In some cases, transmissions may be configured with a periodicity of any integer value between 1 and 99 ms and between 100 ms and 1000 ms in 100 ms intervals.

This example illustrates three reservation periods, a first reservation period 604, a second reservation period 606, and a third reservation period 608 and periodic transmissions 610 may be set by another wireless device during these reservation periods. The first reservation period 604 may have a periodicity of length (P_{reserve 1}), the second reservation period 606 may have a periodicity of length (P_{reserve 2}), and the third reservation period 608 may have a periodicity of length (P_{reserve 3}). In some cases, the periodic transmissions may be new data transmissions and retransmissions of the data may occur within a particular reservation period (not shown). In some cases, the periodic transmissions 610 may include an indication of the corresponding reservation period.

A wireless device may be configured to sense the wireless medium for these periodic transmissions rather than performing continuous sensing (e.g., full sensing) of the medium to help conserve power. The wireless device may perform periodic partial sensing to detect resource reservations for periodic transmissions.

A wireless device in sidelink operations may perform periodic partial sensing to determine when the wireless device may perform a sidelink transmission. The wireless device may determine a set of candidate resources on which the wireless device may transmit. This set of candidate resources may include one or more slots on which the wireless device may transmit. A slot 612 at time t_{y} may be included as a candidate slot in the candidate resource set if the wireless device is configured to monitor slots at t_{y-k·(P}_{ᵣₑₛₑᵣᵥₑ}) corresponding to the slot, where Pᵣₑₛₑᵣᵥₑ is a reservation period and k corresponds to a number of reservation periods prior to the candidate resource in which sensing may be performed (e.g., sensing occasion). For example, another wireless device may periodically transmit periodic transmissions 610A, 610B, and 610C based on the first reservation period 604. If a candidate slot 612 is at time ty, then if a first wireless device were configured to sense within one sensing occasion (k=1), the first wireless device would sense periodic transmission 610A, which occurs at time t_{y-1(P}_{ᵣₑₛₑᵣᵥₑ₁}), one reservation period prior to time t_{y}. Similarly, if first the wireless device were configured to sense within two sensing occasion (k=2) then the first wireless device would sense periodic transmission 610B, which occurs at time t_{y-2(P}_{_{reserve 1}}), two reservation periods prior to time t_{y}, and periodic transmission 610A. Similarly if first the wireless device were configured to sense within three sensing occasion (k=3) then the first wireless device would sense periodic transmission 610C, which occurs at time t_{y-3(P}_{_{reserve 1}}), three reservation periods prior to time t_{y}, as well as periodic transmissions 610B and 610A.

### Sidelink Operations With Overlapping RATs

In some cases, specific frequency bands are allocated for sidelink communications. For example, in the United States, 75 MHz of spectrum in the 5.9 GHz band has been allocated for intelligent transportation services (ITS). Older V2X communications protocols, such as those defined for LTE based V2X, may utilize the ITS band. Newer V2X and D2D protocols, such as NR based protocols may operate in the NR frequency range 1 (FR1) and NR frequency range 2 (FR2) bands. The FR1 band includes frequencies that were used by existing standards, including the frequencies allocated for the ITS band. In current implementations, this frequency overlap is not an issue as NR based V2X protocols can be deployed in different frequencies and/or carriers to avoid existing LTE based V2X deployments (e.g., with different sidelink resource pools). Additionally, existing implementations provide for a priority indication such that if sidelink transmissions from multiple RATs overlap, the transmission lower in priority may be dropped. However, these are not viable solutions in the long-term and techniques for allowing coexistence of multiple sidelink RATs, such as LTE and NR based protocols, in overlapping frequency bands would be useful.

### Coexistence of Multiple Sidelink RATs

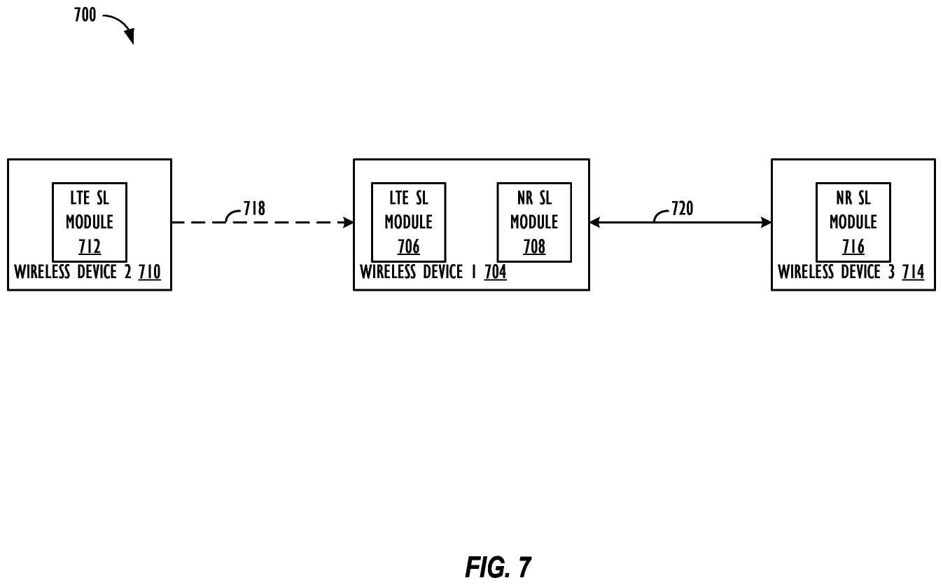

FIG. 7 illustrates a wireless sidelink communications system 700 with multiple sidelink RAT coexistence, in accordance with aspects of the present disclosure. As shown, system 700 involves two sidelink RATs, a legacy sidelink RAT, such as LTE sidelink, and a non-legacy sidelink RAT such as an NR sidelink RAT. In this example, both the legacy sidelink RAT and non-legacy sidelink RAT are operating in an autonomous mode without being controlled by a base station (e.g., LTE sidelink mode 4 and NR sidelink mode 2). The system 700 includes a first wireless device 704 capable of wireless sidelink communications with multiple RATs. In this example, the first wireless device 704 includes an LTE sidelink module 706 for communicating with the LTE sidelink RAT and a NR sidelink module 708 for communicating with the NR sidelink RAT. In some cases, the sidelink modules for the wireless devices may be hardware and associated software capable of communicating with a corresponding RAT, such as a modem and software associated with the modem. Additionally, it should be understood that the LTE sidelink module 706 and NR sidelink module 708 may be logical modules and a single modem may be configured to connect to multiple RATs. System 700 also illustrates a legacy sidelink device, such as second wireless device 710, capable of sidelink communications on a legacy sidelink RAT, such as LTE sidelink via a LTE sidelink module 712.

Generally, it can be assumed that legacy wireless devices, such as the second wireless device 710 operates in accordance with legacy sidelink behavior as it can be difficult to update legacy wireless devices. Non-legacy wireless devices, such as the first wireless device 704 may need to accommodate legacy devices. In some cases, intermediate devices, such as a third wireless device 714 may be capable of establishing sidelink communications 720 with non-legacy wireless devices, for example using NR sidelink via an NR sidelink module 716, but not capable of establishing sidelink communications with legacy wireless device, for example via LTE sidelink.

In this example, the first wireless device 704 may initially be communicating with the third wireless device 714 via a NR sidelink RAT operating in mode 2. The first wireless device 704 may be unaware of the second wireless device 710. This second wireless device 710 may be communicating with another wireless device (not shown) via an LTE sidelink RAT operating in mode 4. The second wireless device 710 may periodically transmit 718 LTE sidelink signals including sidelink control information (SCI) on a physical sidelink control channel (PSCCH). The SCI includes information about resources reserved for retransmissions as well as information about future resource reservations along with periodicity information. The first wireless device 704 may listen for (e.g., sense) the wireless medium and detect the LTE sidelink signals including the SCI using the LTE sidelink module 706. The LTE sidelink module 706 may decode the SCI and generate an intra-UE report and send the intra-UE report to the NR sidelink module 708. The intra-UE report may indicate that the LTE sidelink transmission was detected as well as indicate the resources reserved in the SCI for the LTE sidelink RAT.

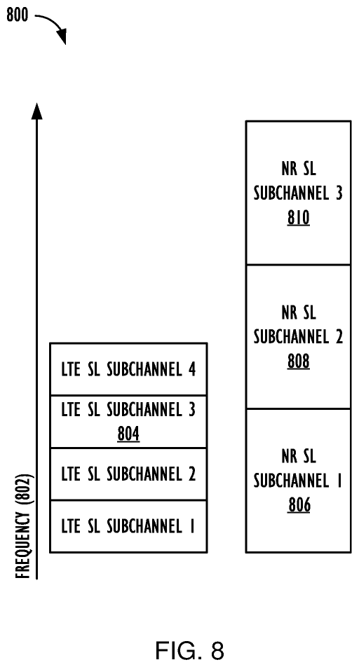

The NR sidelink module 708 may convert the resource reservation information from the intra-UE report in both the time domain and the frequency domain from a format of LTE sidelink RAT to a format compatible with the NR sidelink RAT to determine what corresponding resources in the NR sidelink RAT have been reserved by the LTE sidelink operations to avoid conflicts. As shown in FIG. 8, which is a conceptual resource diagram 800 illustrating a comparison of sidelink subchannel sizes in a frequency domain, sizing of a legacy SL subcarrier, such as LTE sidelink may differ from sizing of non-legacy subcarriers, such as NR sidelink. Diagram 800 includes a vertical frequency axis 802 illustrating a set of frequency resources which a set of LTE sidelink subchannels may use. A size of the LTE sidelink subchannels may be based on the number of physical resource blocks (PRBs) allocated for each subchannel and thus number may be adjusted based on a configuration of the subchannels. Additionally, while LTE and NR transmissions may include the same number of subcarriers per RB, the subcarrier spacing as between the subcarriers can be up to 60 kHZ in NR sidelink in FR1, as opposed to 15 kHZ in LTE sidelink. Additionally, NR sidelinks include four TX slots in each subframe (1 ms) if the NR sidelink is operating with 60 KHz subcarrier spacing, while LTE sidelink can only allow each sidelink transmission to occupy an entire subframe. Thus, one allocated LTE subframe may overlap with four NR sidelink slots. Thus, the numerology as between subcarrier/RBs in LTE may need to be converted to match the numerology for NR. This conversion may be performed for both periodic/aperiodic resource reservations as well as resource preemption and reevaluations. Once converted, the resources used or reserved by the LTE sidelink RAT may be mapped against the sidelink resource pool of the NR sidelink RAT to help determine one or more candidate resources, for example, by avoiding conflicting resource usage when LTE sidelink and RN sidelink resource pools overlap.

In some cases, avoiding conflicts where the legacy sidelink RAT and non-legacy sidelink RAT are both in an autonomous mode (e.g., LTE sidelink mode 4 and NR sidelink mode 2) may be performed in one of two ways depending on whether the first wireless device 704 should receive the LTE sidelink transmissions. In some cases, such as for an LTE V2X broadcast, the first wireless device 704 should receive one or more of the scheduled LTE sidelink transmissions as, in this example, these LTE V2X broadcast message are basic safety announcement messages for vehicle safety. In such cases, the first wireless device 704 cannot transmit on any subchannel during the time when the transmission is schedule to be received (e.g., during the conflict in the time domain). as the first wireless device would not be able to receive the scheduled LTE sidelink transmission. This type of conflict may be referred to as a half-duplex conflict.

Where the wireless device, for example, is already scheduled to transmit and has a half-duplex conflict, the first wireless device may compare priority values to determine which transmission has a higher priority and drop the lower priority one. For example, if the first wireless device 704 is scheduled to receive an LTE sidelink transmission and there is a half-duplex conflict with a scheduled transmission on the NR sidelink RAT by the first wireless device 704, the first wireless device 704 may compare the LTE sidelink a proximity service per-packet priority (PPPP) value (e.g., from an SCI message) with a NR sidelink priority value for the NR sidelink transmission to determine which message has a higher priority. The first wireless device 704 may then transmit the message with the higher priority.

In other cases, such as if the second wireless device 710 is transmitting to another wireless device (not shown) and is not connected to the first wireless device 704, the first wireless device 704 does not need to receive the scheduled LTE sidelink transmission. The first wireless device 704 may sense and detect messages transmitted on the LTE RAT and decode the SCI, but the first wireless device 704 does not need to receive the messages themselves. In such cases, the non-legacy wireless device may perform sensing of both the non-legacy sidelink resources pool and an overlapping portion of the legacy sidelink resources pool. For example, the first wireless device 704 may sense the NR sidelink resources pool as well as portions of the LTE sidelink resources pool which overlap the NR sidelink resources pool. In another embodiment, the device 704 may sense the whole LTE sidelink resources pool and only identify used or reserved legacy resource(s) which overlap with the NR sidelink resource pool.

The non-legacy wireless device may sense the non-legacy and legacy sidelink resources pool based on the sensing configuration of the non-legacy sidelink resources pool and ignore the sensing configuration of legacy sidelink resources pool. For example, where partial sensing is configured for the LTE sidelink resources pool and full sensing is configured for the NR sidelink resources pool, the first wireless device may use full sensing for the NR sidelink resources pool as well as the LTE sidelink resources pool. As another example, if full sensing and partial sensing (e.g., where either may be performed) is configured for the LTE sidelink resources pool and partial sensing is configured for the NR sidelink resources pool, the first wireless device may use partial sensing for the NR sidelink resources pool as well as the LTE sidelink resources pool. Where the legacy sidelink resources pool is only configured with full sensing and the non-legacy sidelink resources pool is configured with less than full sensing, the non-legacy wireless device may use full sensing on the legacy sidelink resources pool and less than full sensing for the non-legacy sidelink resources pool. For example, if full sensing is configured for the LTE sidelink resources pool and partial sensing is configured for the NR sidelink resources pool, the first wireless device may use partial sensing for the NR sidelink resources pool and full sensing for the LTE sidelink resources pool.

Where the non-legacy wireless device senses the resource pool of the legacy sidelink RAT, but does not need to receive the messages themselves, the non-legacy wireless device may, in some cases, not transmit on the overlapping non-legacy sidelink subchannels. For example, the first wireless device 704 may not to transmit on NR sidelink subchannels which overlap with the subchannels scheduled for use by the LTE sidelink RAT in the time domain. Rather, the first wireless device 704 may select other NR sidelink subchannels.

As an example, if the first wireless device 704 senses a transmission scheduled on LTE sidelink subchannel 804, the first wireless device 704 may not transmit on NR sidelink subchannel 1 806 and NR sidelink subchannel 2 808 during the time when the transmission is schedule to be received. The first wireless device 704 may still be able to transmit on NR sidelink subchannel 3 810.

In some cases, the first wireless device 704 may be able to transmit on a portion of a NR sidelink subchannel that partially overlaps with a scheduled LTE sidelink subchannel. For example, when the scheduled LTE sidelink subchannel overlaps less than a threshold portion of the NR sidelink subchannel, the NR wireless device may be able to schedule the transmission to use less than all of the NR sidelink subchannel and avoid the overlapping portion. This scheduling may be performed, for example, by frequency domain modulating the device 704's own transmission with the detected LTE sidelink communication in the same overlapping subframe/slot.

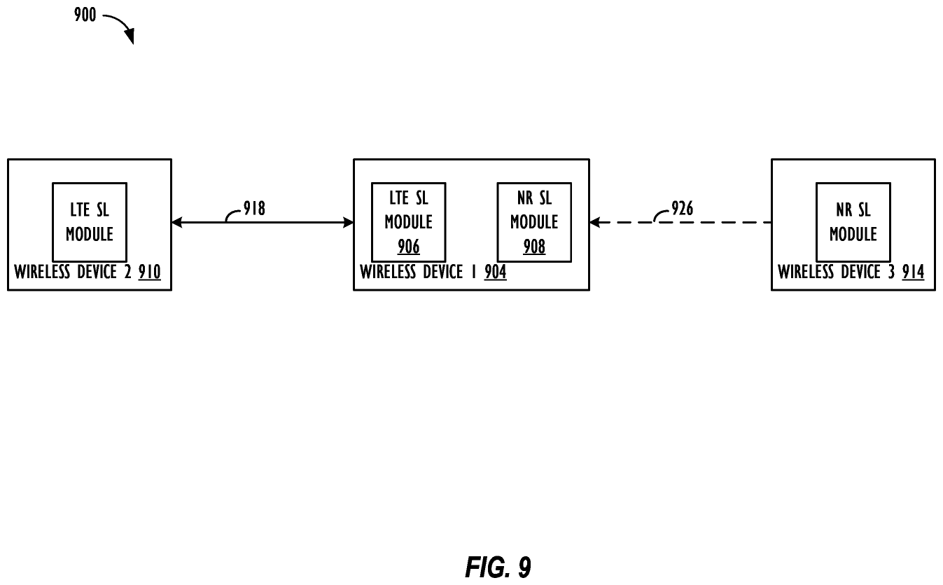

FIG. 9 illustrates a wireless sidelink communications system 900 with multiple sidelink RAT coexistence, in accordance with aspects of the present disclosure. As shown, system 900 is similar to system 700 with two sidelink RATs, a legacy sidelink RAT, such as LTE sidelink, and a non-legacy sidelink RAT such as an NR sidelink RAT where both the legacy sidelink RAT and non-legacy sidelink RAT are operating in an autonomous mode without being controlled by a base station (e.g., LTE sidelink mode 4 and NR sidelink mode 2).

System 900 is substantially similar to system 700 except that the first wireless device 904, in this example, may initially be communicating with the second wireless device 910 via an LTE sidelink RAT operating in mode 4. The first wireless device 904 may initially be unaware of the third wireless device 914. This third wireless device 914 may be communicating with another wireless device (not shown) via an NR sidelink RAT operating in mode 2. The third wireless device 914 may periodically transmit 926 NR sidelink signals SCI. The first wireless device 904 may listen for (e.g., sense) the wireless medium and detect the NR sidelink signals including the SCI using the NR sidelink module 908. The NR sidelink module 908 may decode the SCI and generate an intra-UE report and send the intra-UE report to the LTE sidelink module 906. The intra-UE report may indicate that the NR sidelink transmission was detected as well as indicate the resources reserved in the SCI for the NR sidelink RAT. The LTE sidelink module 906 may convert the resource reservation information from the intra-UE report in both the time domain and the frequency domain from a format of NR sidelink RAT to a format compatible with the LTE sidelink RAT to determine what corresponding resources in the LTE sidelink RAT have been reserved by the NR sidelink operations to avoid conflicts. This conversion is similar to, but reverses, the process for converting the resource reservation information for the LTE sidelink RAT to a format compatible with the NR sidelink RAT as discussed above in conjunction with FIG. 7.

Similarly, to avoid conflicts between the legacy sidelink RAT and the non-legacy sidelink RAT, the first wireless device 904 may take into account the resource reservations by the NR sidelink RAT when selecting resources from the LTE sidelink resource pool. The selection of resources from the LTE sidelink resource pool while taking into account the NR sidelink RAT resource reservations may be substantially similar to that discussed above with respect to FIG. 7.

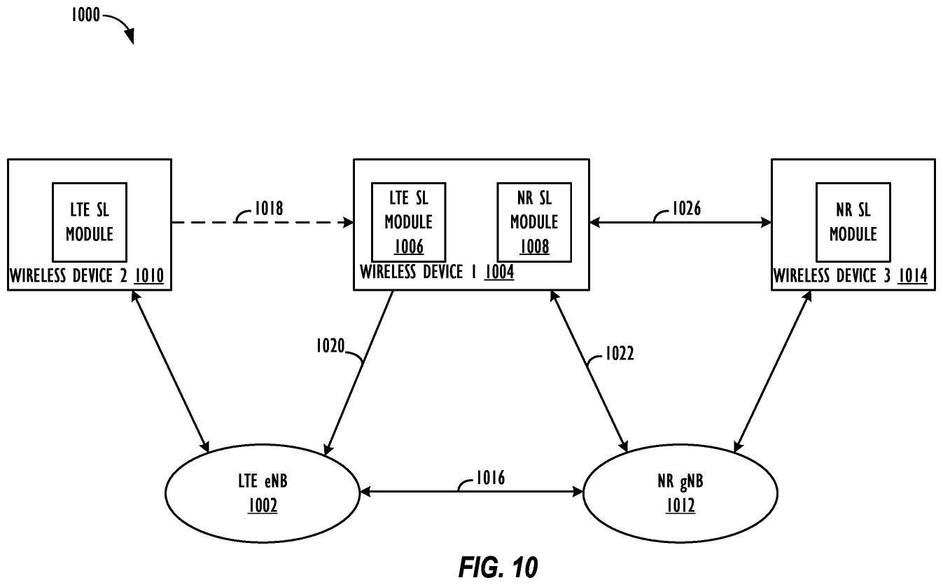

FIG. 10 illustrates a wireless sidelink communications system 1000 with multiple sidelink RAT coexistence, in accordance with aspects of the present disclosure. System 1000 includes two sidelink RATs, a legacy sidelink RAT (e.g., LTE sidelink) operating in mode 3, and a non-legacy sidelink RAT (e.g., NR sidelink) operating in mode 1. In some cases, the base stations may indicate that the base station supports co-channel coexistence to wireless devices connected to the base station. This indication may be sent, for example, as a part of configuring the wireless device for the sidelink RAT controlled by the base station. In some cases, this indication may be sent in an RRC message from the base station. In the example system 1000, the first wireless device 1004 may initially be communicating 1026 with the third wireless device 1014 via an NR sidelink RAT using resources allocated by an NR gNB 1012. The first wireless device 1004 may initially be unaware of the second wireless device 1010. The second wireless device 1010 may periodically transmit 1018 LTE sidelink signals with SCI information. The first wireless device 1004 may listen for (e.g., sense) the wireless medium and detect the LTE sidelink signals, for example, using the LTE sidelink module 1006. The first wireless device 1004 may then report 1022 the detected LTE sidelink usage and scheduling information to the NR gNB 1012 or report 1020 detected LTE sidelink usage and scheduling information to the LTE eNB 1002. In some cases, reporting to LTE eNB 1002 via signaling 1020 may be used when the LTE eNB 1002 is capable of cross RAT scheduling (i.e., LTE scheduling NR SL mode 1).

As an example, the first wireless device 1004 may report the detected LTE sidelink signal to the NR gNB 1012 using the NR sidelink module 1008 to generate an NR RRC message indicating the resources scheduled by the LTE sidelink signals, such as via a UEAssistanceInformationNR message, so that gNB can avoid those resources when scheduling in mode 1. In another example, the first wireless device 1004 may report the indication of the resources scheduled in the LTE sidelink signal to the NR gNB 1012 via a type of a MAC control element (MAC CE), such as a buffer status report (BSR). The BSR may indicate resources determined by the NR sidelink RAT as overlapped resources that are not to be scheduled so that gNB can avoid those resources when scheduling in mode 1.

In some cases, the resources scheduled for the detected sidelink RAT may be indicated in many ways. For example, the indication of the set of resources used by the detected sidelink RAT may report resources occupied by or overlapping by the detected sidelink RAT. As another example, the indication of the set of resources used by the detected sidelink RAT may be report resources not occupied by the detected sidelink RAT. In another example, the indication of the set of resources used by the detected sidelink RAT may be a bitmap indicating both occupied and unoccupied resources. As an example of the bitmap, for NR, each slot may be represented by a binary value which indicates whether the slot is occupied or not occupied by the detected sidelink RAT.

After the NR gNB 1012 receives the indication of the detected sidelink signals via report 1022, the NR gNB may determine what portions of the NR sidelink resources may be used.

In some cases, the NR gNB 1012 may coordinate with the LTE eNB 1002 controlling the LTE sidelink RAT via inter-base station communications 1016 to determine how to avoid overlapping resources. The NR gNB 1012 may then adjust the dynamic sidelink grants or configured sidelink grants to the wireless devices in the NR sidelink RAT. After receiving the sidelink grants, the wireless devices on the NR sidelink RAT may then use the allocated sidelink grants for NR sidelink transmissions.

As an example, where the NR gNB 1012 is absent from the example depicted in FIG. 10 and where the LTE eNB 1002 is capable of cross-RAT scheduling, the first wireless device 1004 may use the LTE sidelink module 1006 to generate an LTE radio resource control (RRC) message which is used for sidelink resource pool sharing to the LTE eNB 1002 via signaling 1020. The RRC message may indicate to the LTE eNB 1002 resource pool sensing information and/or information regarding resource usage by the legacy LTE sidelink RAT. As another example, the first wireless device 1004 may use the NR sidelink module 1008 to transmit 1020 the indication of the detected sidelink signals as an LTE RRC message encapsulating an NR RRC message. The encapsulating LTE RRC message may include usage and scheduling information for LTE sidelink which overlap with the NR sidelink RAT. After LTE eNB 1002 receives this information, as the LTE eNB 1002 is capable of cross-RAT scheduling and there is no gNB 1012 in this case, the LTE eNB 1002 will schedule mode 1 grants to wireless device 1004 to avoid any resources that may be in conflict with LTE SL communication. If gNB 1012 is present in this scenario, the LTE eNB 1002 may use inter eNB/gNB communications 1016 to coordinate with the NR gNB 1012 to determine how to avoid overlapping resources. The NR gNB 1012 and/or LTE eNB 1002 may then adjust the sidelink resources allocated to the wireless devices in the NR sidelink RAT and/or LTE sidelink RAT to avoid overlaps.

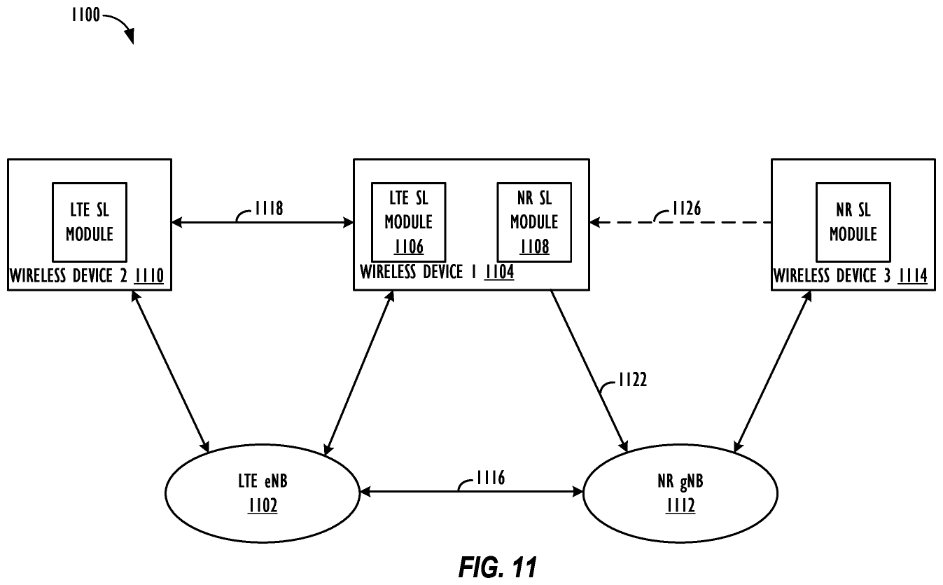

FIG. 11 illustrates a wireless sidelink communications system 1100 with multiple sidelink RAT coexistence, in accordance with aspects of the present disclosure. System 1100 is similar to system 1000 with two sidelink RATs, a legacy sidelink RAT (e.g., LTE sidelink) operating in mode 3, and a non-legacy sidelink RAT (e.g., NR sidelink) operating in mode 1. In this example, the first wireless device 1104 may initially be communicating 1118 with the second wireless device 1110 via an LTE sidelink RAT using resources allocated by an LTE eNB 1102. The first wireless device 1104 may initially be unaware of the third wireless device 1114. This third wireless device 1114 may be communicating with another wireless device (not shown) via an NR sidelink RAT using resources allocated by NR eNB 1112. The third wireless device 1114 may periodically transmit 1126 NR sidelink signals with SCI information. The first wireless device 1104 may listen for (e.g., sense) the wireless medium and detect the NR sidelink signals, for example, using the NR sidelink module 1106. The first wireless device 1104 may then report the detected NR sidelink signal to either the LTE eNB 1102 or the NR gNB 1112. In some cases, reporting to the NR gNB 1112 via signaling 1122 is may be used when NR gNB 1112 is capable of cross RAT scheduling (i.e., NR scheduling LTE SL mode 3).

Where the first wireless device 1104 reports the detected NR sidelink signal to the LTE eNB 1102, the first wireless device 1104 may report the detected NR sidelink signal to the LTE eNB 1102 using the LTE sidelink module 1006 to generate an LTE RRC message reporting the indication of the resources scheduled in the detected NR sidelink signals. The resources scheduled for the detected sidelink RAT may be indicated using any technique as discussed above in conjunction with FIG. 10. The LTE eNB 1102 may use inter eNB/gNB communications 1116 to coordinate with the NR gNB 1112 to determine how to avoid overlapping resources. The NR gNB 1112 and/or LTE eNB 1102 may then adjust the sidelink resources allocated to the wireless devices in the NR sidelink RAT and/or LTE sidelink RAT to avoid overlaps.

As an example where cross-RAT scheduling signaling is used, the first wireless device 1104 may use the NR sidelink module 1008 to generate an NR RRC message to the NR gNB 1112 via signaling 1122. The NR gNB 1112 may then adjust the dynamic sidelink grants or configured sidelink grants to the wireless devices in the LTE sidelink RAT. After receiving the sidelink grants, the wireless devices on the LTE sidelink RAT may then use the allocated sidelink grants for LTE sidelink transmissions.

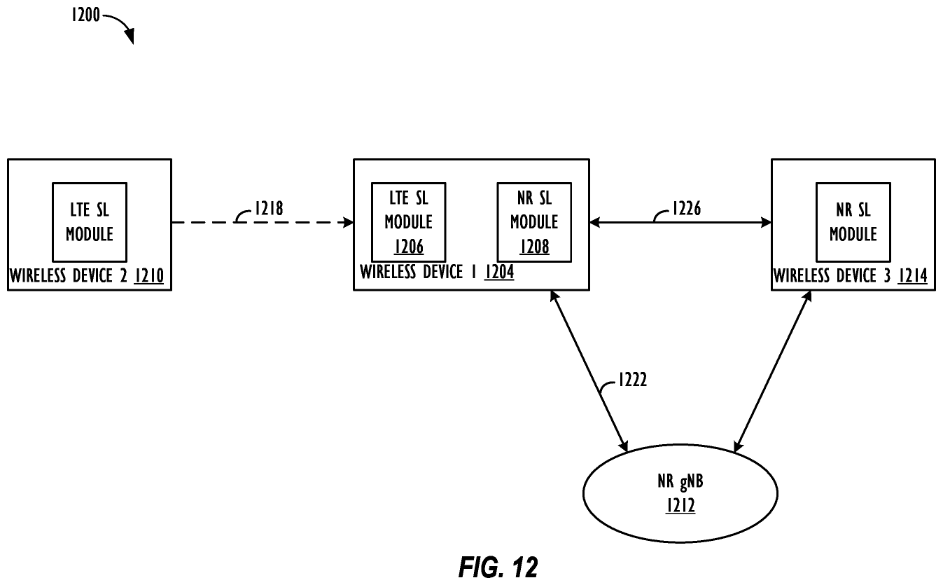

FIG. 12 illustrates a wireless sidelink communications system 1200 with multiple sidelink RAT coexistence, in accordance with aspects of the present disclosure. System 1200 includes two sidelink RATs, a legacy sidelink RAT (e.g., LTE sidelink) operating in mode 4, and a non-legacy sidelink RAT (e.g., NR sidelink) operating in mode 1. In this example, the first wireless device 1004 may initially be communicating 1226 with the third wireless device 1214 via an NR sidelink RAT using resources allocated by an NR gNB 1212. The first wireless device 1204 may initially be unaware of the second wireless device 1210. The second wireless device 1210 may periodically transmit 1218 LTE sidelink signals with SCI information indicating the resource reservations in the legacy RAT (e.g., for LTE sidelink). The first wireless device 1204 may listen for (e.g., sense) the wireless medium and detect the LTE sidelink signals, for example, using the LTE sidelink module 1206. The first wireless device 1204 may then report 1222 the detected LTE sidelink usage and scheduling information to the NR gNB 1212. This reporting may be performed in a way substantially similar to that discussed above with respect to FIG. 10 and reporting to the NR gNB 1012. The NR gNB 1212 may then adjust the dynamic sidelink grants or configured sidelink grants to the wireless devices in the NR sidelink RAT. After receiving the sidelink grants, the wireless devices on the NR sidelink RAT may then use the allocated sidelink grants for NR sidelink transmissions.

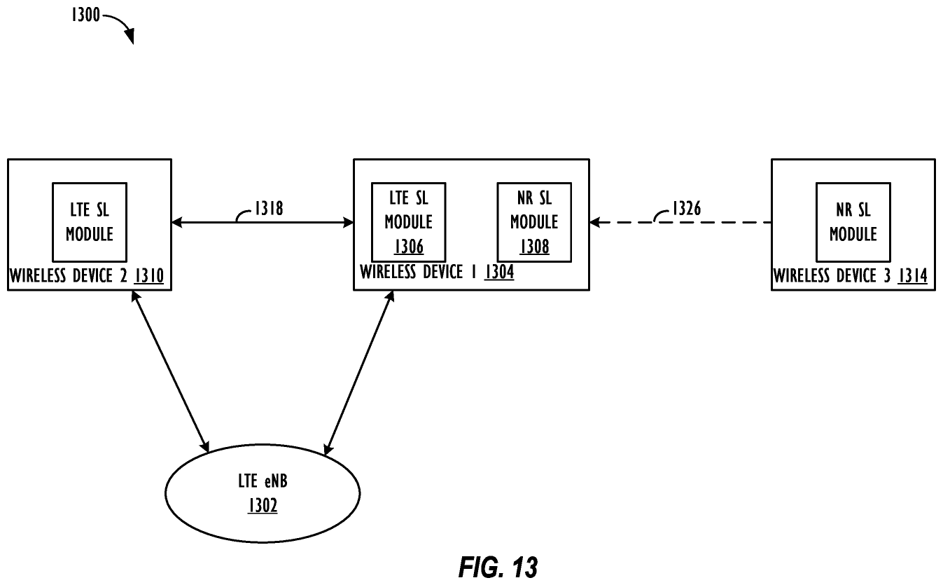

FIG. 13 illustrates a wireless sidelink communications system 1300 with multiple sidelink RAT coexistence, in accordance with aspects of the present disclosure. System 1300 is similar to system 1200 with two sidelink RATs, a legacy sidelink RAT (e.g., LTE sidelink) operating in mode 3, and a non-legacy sidelink RAT (e.g., NR sidelink) operating in mode 2. In this example, the first wireless device 1304 may initially be communicating 1318 with the second wireless device 1310 via an LTE sidelink RAT using resources allocated by an LTE eNB 1302. The first wireless device 1304 may initially be unaware of the third wireless device 1314. This third wireless device 1314 may be communicating with another wireless device (not shown) via an NR sidelink RAT using resources allocated autonomously. The third wireless device 1314 may periodically transmit 1326 NR sidelink signals with SCI information. The first wireless device 1304 may listen for (e.g., sense) the wireless medium and detect the NR sidelink signals, for example, using the NR sidelink module 1306. The first wireless device 1104 may then report the detected NR sidelink signal to the LTE eNB 1302. This reporting may be performed in a way substantially similar to that discussed above with respect to FIG. 11 and reporting to the LTE eNB 1102. The LTE eNB 1302 may then adjust the sidelink grants to the wireless devices in the LTE sidelink RAT. After receiving the sidelink grants, the wireless devices on the LTE sidelink RAT may then use the allocated sidelink grants for LTE sidelink transmissions.

In some cases, intra-UE multiple sidelink RAT coexistence may be addressed in a way substantially similar to inter-UE multiple sidelink RAT coexistence. For example, once a set of resources are selected using any of the techniques discussed above with respect to FIGS. 7 and 9-13, scheduling of the sidelink modules of the multiple RATs in a wireless device may mirror the resource scheduling in the time domain. As conflicts for intra-UE scheduling of the sidelink modules of the multiple RATs can be detected during the scheduling stage, intra-UE conflicts may be avoided prior to transmission of intra-RAT transmissions. This early detection may help reduce the overall latency of intra-UE coordination/prioritization and improve the successful rate of co-existence. The intra-UE reporting latency may be a fixed delay based on UE implementation. But if the reporting of potential resource usage can be triggered earlier, then the UE will have more time to reselect a proper resource to avoid the conflict. In this case, whenever the sidelink transmission is scheduled in the sidelink module of one RAT, internal intra-UE reporting can be used to immediately notify the sidelink module of another RAT to take this into account and this notification can be faster than the detection based on SCI signals, such as those transmitted by another UE. If there are still overlapping scheduled transmissions, then prioritization of the transmissions may be used.

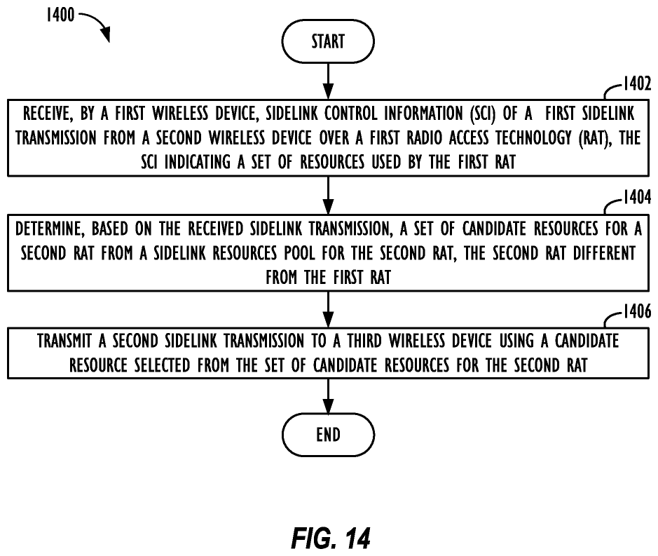

FIG. 14 is a flow diagram 1400 illustrating a technique for wireless sidelink communications, in accordance with aspects of the present disclosure. At block 1402, a first wireless device receives sidelink control information (SCI) of a first sidelink transmission from a second wireless device over a first radio access technology (RAT), the SCI indicating a set of resources used by the first RAT. As a first example as shown in FIG. 7, a wireless device performing sidelink operations in an NR sidelink RAT may detect a transmission from another wireless device associated with an LTE sidelink RAT. As a second example as shown in FIG. 8, a wireless device performing sidelink operations in an LTE sidelink RAT may detect a transmission from another wireless device associated with an NR sidelink RAT.

In either the first example or the second example, the first wireless device may determine a first sensing configuration for the second RAT and sense a wireless medium based on the first sensing configuration. In the first example, the first wireless device may determine that the NR sidelink RAT is configured for either full or partial sensing. The first wireless device may determine a sensing configuration for the LTE sidelink RAT. The first wireless device may then continue to sense resources for the LTE sidelink RAT using the sensing configuration for the NR sidelink RAT. In cases where the LTE sidelink RAT is configured with full sensing and the NR sidelink RAT is configured for partial sensing, the first wireless device may use full sensing for resources for the LTE sidelink RAT. Similarly, in the second example, the first wireless device may determine that the LTE sidelink RAT is configured for either full or partial sensing. The first wireless device may determine a sensing configuration for the NR sidelink RAT. The first wireless device may then continue to sense resources for the NR sidelink RAT using the sensing configuration for the LTE sidelink RAT. In cases where the LTE sidelink RAT is configured with full sensing and the NR sidelink RAT is configured for partial sensing, the first wireless device may use full sensing for the LTE sidelink RAT. Generally, where a UE is configured to transmit in a sidelink RAT where the sidelink RAT is configured for full sensing, then the UE may use full sensing in that sidelink RAT and any other sidelink RATs the UE may be detecting or connected to.

At block 1404, the wireless device determines, based on the received sidelink transmission, a set of candidate resources for a second RAT from a sidelink resources pool for the second RAT, the second RAT different from the first RAT. Returning to the first example, the first wireless device may determine based on the received SCI information resources schedule for use by the LTE sidelink RAT. The wireless device may convert the scheduled resources to a corresponding set of resources for NR sidelink and determine whether the schedule resources overlap with candidate resources in the NR sidelink resources pool. For such common resources, the wireless device may determine whether a transmission from the wireless device may overlap with the corresponding transmission in the LTE sidelink RAT. The wireless device may determine to receive a third transmission scheduled in the LTE sidelink RAT and the wireless device may then determine that a transmission of the wireless device cannot overlap the scheduled third transmission and refrain from scheduling an overlapping transmission from the first wireless device. Alternatively, if the wireless device determines that there is no need to receive the third transmission scheduled in the LTE sidelink RAT, the wireless device may determine that a transmission of the wireless device may overlap the scheduled third sidelink transmission and schedule a transmission by the first wireless device on a resource which overlaps resources of the third sidelink transmission.

Similarly for the second example, the first wireless device may determine based on the received SCI information resources schedule for use by the NR sidelink RAT. The wireless device may convert the scheduled resources to a corresponding set of resources for LTE sidelink and determine whether the schedule resources overlap with candidate resources in the LTE sidelink resources pool. For such common resources, the wireless device may determine whether a transmission from the wireless device may overlap with the corresponding transmission in the NR sidelink RAT. The wireless device may determine to receive a third transmission scheduled in the NR sidelink RAT and the wireless device may then determine that a transmission of the wireless device cannot overlap the scheduled third transmission and refrain from scheduling an overlapping transmission from the first wireless device. Alternatively, if the wireless device determines that there is no need to receive the third transmission scheduled in the NR sidelink RAT, the wireless device may determine that a transmission of the wireless device may overlap the scheduled third sidelink transmission and schedule a transmission by the first wireless device on a resource which overlaps resources of the third sidelink transmission.

At block 1406, the first wireless device transmits a second sidelink transmission to a third wireless device using a candidate resource selected from the set of candidate resources for the second RAT. For example, once the candidate resources are selected for transmission, a resource from the candidate resources may be used to transmit a sidelink transmission.

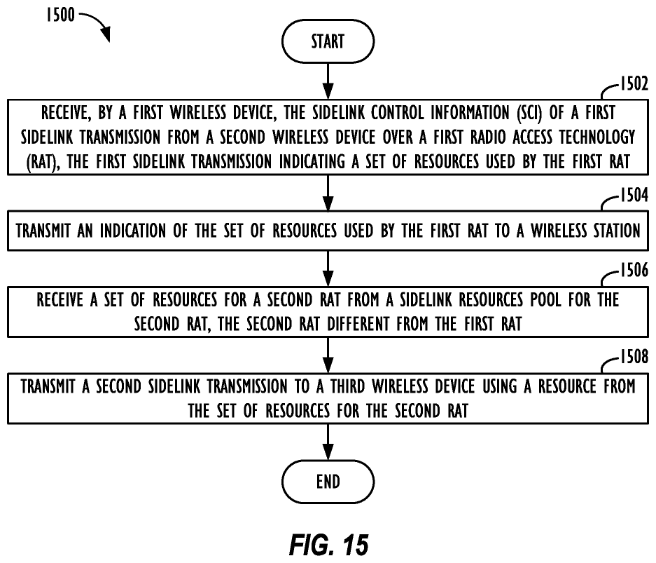

FIG. 15 is a flow diagram illustrating a technique 1500 for wireless sidelink communications, in accordance with aspects of the present disclosure. At block 1502, a first wireless device receives sidelink control information (SCI) of a first sidelink transmission from a second wireless device over a first radio access technology (RAT), the first sidelink transmission indicating a set of resources used by the first RAT. As a third example as shown in FIGS. 10 and 12, a wireless device performing sidelink operations in an NR sidelink RAT may detect a transmission from another wireless device associated with an LTE sidelink RAT. As a fourth example as shown in FIGS. 11 and 13, a wireless device performing sidelink operations in an LTE sidelink RAT may detect a transmission from another wireless device associated with an NR sidelink RAT. In some cases, the first wireless device may determine a sensing configuration in a way substantially similar to that discussed above. For the third example, sensing may be performed by the first wireless device in a manner similar to sensing as discussed above with respect to the first example for FIG. 14. For the fourth example, sensing may be performed by the first wireless device in a manner similar to sensing as discussed above with respect to the second example for FIG. 14.

At block 1504, the first wireless device transmits an indication of the set of resources used by the first RAT to a base station. In both the third and fourth examples, the first wireless device may decode the received SCI and transmit the indication of the set of resources used by the first RAT based on the decoded SCI. Returning to the third example, the first wireless device may transmit the indication of the set of resources allocated by the LTE sidelink RAT to a gNB controlling the NR sidelink RAT using an RRC message. This RRC message may be formatted for the NR sidelink RAT. In some cases, the indication of the set of resources allocated by the LTE sidelink RAT may be transmitted to a gNB controlling the NR sidelink RAT using a MAC CE message, such as in a buffer status report. The gNB may the determine how to allocate resources of the NR sidelink RAT based on the indication of the set of resources allocated by the LTE sidelink RAT. The gNB may use inter-base station signaling to negotiate resources as between the LTE sidelink RAT and the NR sidelink RAT where the LTE sidelink RAT is controlled by an eNB.

In some cases, for the third example, the wireless device may determine, based on the SCI, that the LTE sidelink RAT is controlled by an eNB. In some such cases, the indication of the set of resources allocated by the LTE sidelink RAT may be transmitted to an eNB controlling the LTE sidelink RAT using a cross-RAT scheduling message. In some cases, the first wireless device may transmit to the eNB using an LTE formatted RRC message generated, for example, by an LTE module of the first wireless device. In some cases, the first wireless device may encapsulate an NR RRC message in an LTE RRC message format for transmission to the eNB. The eNB and gNB may use inter-base station signaling to negotiate resources as between the LTE sidelink RAT and the NR sidelink RAT.

In the fourth example, the first wireless device may transmit the indication of the set of resources allocated by the NR sidelink RAT to an eNB controlling the LTE sidelink RAT using an RRC message. This RRC message may be formatted for the LTE sidelink RAT. The eNB may the determine how to allocate resources of the LTE sidelink RAT based on the indication of the set of resources allocated by the NR sidelink RAT. The eNB may use inter-base station signaling to negotiate resources as between the LTE sidelink RAT and the NR sidelink RAT where the NR sidelink RAT is controlled by an gNB.

In some cases, for the fourth example, the wireless device may determine, based on the SCI, that the NR sidelink RAT is controlled by a gNB. In some such cases, the indication of the set of resources allocated by the NR sidelink RAT may be transmitted to the gNB controlling the NR sidelink RAT using a cross-RAT scheduling message. In some cases, the first wireless device may transmit to the gNB using an NR formatted RRC message generated, for example, by an NR module of the first wireless device. In some cases, the first wireless device may transmit to the gNB controlling the NR sidelink RAT using a MAC CE message, such as in a buffer status report. The eNB and gNB may use inter-base station signaling to negotiate resources as between the LTE sidelink RAT and the NR sidelink RAT.

At block 1506, the first wireless device receives a set of resources for a second RAT from a sidelink resources pool for the second RAT, the second RAT different from the first RAT. For example, in the third example, the first wireless device receives an allocation for an NR sidelink transmission from the gNB. In the fourth example, the first wireless device receives an allocation for an LTE sidelink transmission from the eNB

At block 1508, the first wireless device transmits a second sidelink transmission to a third wireless device using a resource from the set of resources for the second RAT. For example, in the third example, the first wireless device may transmit data to another wireless device based on the resource allocation from the gNB. In the fourth example, the first wireless device may transmit data to another wireless device based on the resource allocation from the eNB.

### EXAMPLES

In the following sections, further exemplary aspects are provided.

According to Example 1, a method for wireless communications, comprising: receiving, by a first wireless device, sidelink control information (SCI) of a first sidelink transmission from a second wireless device over a first radio access technology (RAT), the SCI indicating a set of resources used by the first RAT; determining, based on the received sidelink transmission, a set of candidate resources for a second RAT from a sidelink resources pool for the second RAT, the second RAT different from the first RAT; and transmitting a second sidelink transmission to a third wireless device using a candidate resource selected from the set of candidate resources for the second RAT.

Example 2 comprises the subject matter of example 1, wherein the set of candidate resources are determined based on whether a transmission of the first wireless device can overlap with resources used by the first RAT.

Example 3 comprises the subject matter of example 2, further comprising: determining that the first wireless device does not need to receive a third sidelink transmission scheduled in the set of resources; determining that resources of the set of candidate resources can overlap resources of the third sidelink transmission based on the determination that the first wireless device does not need to receive the third sidelink transmission; and scheduling a transmission, by the first wireless device, on a resource which overlaps the resources of the third sidelink transmission.

Example 4 comprises the subject matter of example 1, further comprising: determining to receive a third sidelink transmission scheduled in the set of resources used by the first RAT; determining that a transmission of the first wireless device cannot overlap the scheduled third sidelink transmission based on the determination to receive the third sidelink transmission; and refraining from scheduling a transmission, by the first wireless device, during the third sidelink transmission.

Example 5 comprises the subject matter of example 1, further comprising: converting the set of resources used by the first RAT to a corresponding set of resources in the second RAT; determining a set of common resources based on the corresponding set of resources; and determining the set of candidate resources for the second RAT based on the set of common resources.

Example 6 comprises the subject matter of example 2, further comprising: determining a first sensing configuration for the second RAT, and sensing a wireless medium based on the first sensing configuration for the second RAT.

Example 7 comprises the subject matter of example 6, further comprising sensing the set of common resources based on the sensing configuration for the second RAT.

Example 8 comprises the subject matter of example 6, further comprising: determining that full sensing is configured for the first RAT; determining that partial sensing is configured for the second RAT; and sensing the set of common resources using full sensing.

According to example 9, a method for wireless communications, comprising: receiving, by a first wireless device, the sidelink control information (SCI) of a first sidelink transmission from a second wireless device over a first radio access technology (RAT), the first sidelink transmission indicating a set of resources used by the first RAT; transmitting an indication of the set of resources used by the first RAT to a base station; receiving a set of resources for a second RAT from a sidelink resources pool for the second RAT, the second RAT different from the first RAT; and transmitting a second sidelink transmission to a third wireless device using a resource from the set of resources for the second RAT.

Example 10 comprises the subject matter of example 9, further comprising: receiving the set of resources for the second RAT from the base station, wherein the set of candidate resources is determined from the received set of candidate resources.

Example 11 comprises the subject matter of example 9, wherein the indication of the set of resources is transmitted using a radio resource control (RRC) message.

Example 12 comprises the subject matter of example 11, wherein the RRC message comprises a RRC message formatted for the first RAT.

Example 13 comprises the subject matter of example 12, wherein the indication is transmitted to a base station associated with the first RAT via cross RAT scheduling signaling.

Example 14 comprises the subject matter of example 11, wherein the RRC message comprises a RRC message formatted for the second RAT.

Example 15 comprises the subject matter of example 14, wherein the RRC message encapsulates a message format of the first RAT.

Example 16 comprises the subject matter of example 9, wherein the indication of the set of resources is transmitted using buffer status report message.

Example 17 comprises the subject matter of example 9, further comprising receiving, from the base station, an indication that the base station supports co-channel co-existence in an RRC message from the base station.

According to example 18, a wireless device comprising: a radio; and a processor operably coupled to the radio, wherein the processor is configured to: receive sidelink control information (SCI) of a first sidelink transmission from a second wireless device over a first radio access technology (RAT), the SCI indicating a set of resources used by the first RAT; determine, based on the received sidelink transmission, a set of candidate resources for a second RAT from a sidelink resources pool for the second RAT, the second RAT different from the first RAT; and transmit a second sidelink transmission to a third wireless device using a candidate resource selected from the set of candidate resources for the second RAT.

Example 19 comprises the subject matter of example 18, wherein the set of candidate resources are determined based on whether a transmission of the first wireless device can overlap with resources used by the first RAT.

Example 20 comprises the subject matter of example 19, wherein the processor is further configured to: determine that the first wireless device does not need to receive a third sidelink transmission scheduled in the set of resources; determine that resources of the set of candidate resources can overlap resources of the third sidelink transmission based on the determination that the first wireless device does not need to receive the third sidelink transmission; and schedule a transmission, by the first wireless device, on a resource which overlaps the resources of the third sidelink transmission.

Example 21 comprises the subject matter of example 18, wherein the processor is further configured to: determine to receive a third sidelink transmission scheduled in the set of resources used by the first RAT; determine that a transmission of the first wireless device cannot overlap the scheduled third sidelink transmission based on the determination to receive the third sidelink transmission; and refrain from scheduling a transmission, by the first wireless device, during the third sidelink transmission.

Example 22 comprises the subject matter of example 18, wherein the processor is further configured to: convert the set of resources used by the first RAT to a corresponding set of resources in the second RAT; determine a set of common resources based on the corresponding set of resources; and determine the set of candidate resources for the second RAT based on the set of common resources.

Example 23 comprises the subject matter of example 19, wherein the processor is further configured to: determine a first sensing configuration for the second RAT, and sense a wireless medium based on the first sensing configuration for the second RAT.

Example 24 comprises the subject matter of example 23, wherein the processor is further configured to sense the set of common resources based on the sensing configuration for the second RAT.

Example 25 comprises the subject matter of example 23, wherein the processor is further configured to: determine that full sensing is configured for the first RAT; determine that partial sensing is configured for the second RAT; and sense the set of common resources using full sensing.

According to example 26, a wireless device comprising: a radio; and a processor operably coupled to the radio, wherein the processor is configured to: receive the sidelink control information (SCI) of a first sidelink transmission from a second wireless device over a first radio access technology (RAT), the first sidelink transmission indicating a set of resources used by the first RAT; transmit an indication of the set of resources used by the first RAT to a base station; receive a set of resources for a second RAT from a sidelink resources pool for the second RAT, the second RAT different from the first RAT; and transmit a second sidelink transmission to a third wireless device using a resource from the set of resources for the second RAT.

Example 27 comprises the subject matter of example 26, wherein the processor is further configured to: receive the set of resources for the second RAT from the base station, wherein the set of candidate resources is determined from the received set of candidate resources.

Example 28 comprises the subject matter of example 26, wherein the indication of the set of resources is transmitted using a radio resource control (RRC) message.

Example 29 comprises the subject matter of example 28, wherein the RRC message comprises a RRC message formatted for the first RAT.

Example 30 comprises the subject matter of example 29, wherein the indication is transmitted to a base station associated with the first RAT via cross RAT scheduling signaling.

Example 31 comprises the subject matter of example 28, wherein the RRC message comprises a RRC message formatted for the second RAT.

Example 32 comprises the subject matter of example 31, wherein the RRC message encapsulates a message format of the first RAT.

Example 33 comprises the subject matter of example 26, wherein the indication of the set of resources is transmitted using buffer status report message.

Example 34 comprises the subject matter of example 26, wherein the processor is further configured to receive, from the base station, an indication that the base station supports co-channel co-existence in an RRC message from the base station.

According to Example 35, a method that includes any action or combination of actions as substantially described herein in the Detailed Description.

According to Example 36, a method as substantially described herein with reference to each or any combination of the Figures included herein or with reference to each or any combination of paragraphs in the Detailed Description.

According to Example 37, a wireless device configured to perform any action or combination of actions as substantially described herein in the Detailed Description as included in the wireless device.

According to Example 38, a base station configured to perform any action or combination of actions as substantially described herein in the Detailed Description as included in the base station.

According to Example 39, a non-volatile computer-readable medium that stores instructions that, when executed, cause the performance of any action or combination of actions as substantially described herein in the Detailed Description.

According to Example 40, an integrated circuit configured to perform any action or combination of actions as substantially described herein in the Detailed Description.

Yet another exemplary aspect may include a method, comprising, by a device, performing any or all parts of the preceding Examples.

A yet further exemplary aspect may include a non-transitory computer-accessible memory medium comprising program instructions which, when executed at a device, cause the device to implement any or all parts of any of the preceding Examples.

A still further exemplary aspect may include a computer program comprising instructions for performing any or all parts of any of the preceding Examples.

Yet another exemplary aspect may include an apparatus comprising means for performing any or all of the elements of any of the preceding Examples.

Still another exemplary aspect may include an apparatus comprising a processor configured to cause a device to perform any or all of the elements of any of the preceding Examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method, e.g., any of a method aspects described herein, or, any combination of the method aspects described herein, or, any subset of any of the method aspects described herein, or, any combination of such subsets.

In some aspects, a device (e.g., a communication device 106, a BS 102, etc.) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method for wireless communications, comprising:
receiving, by a first wireless device, sidelink control information (SCI) of a first sidelink transmission from a second wireless device over a first radio access technology (RAT), the SCI indicating a set of resources used by the first RAT;
determining, based on the received sidelink transmission, a set of candidate resources for a second RAT from a sidelink resources pool for the second RAT, the second RAT different from the first RAT; and
transmitting a second sidelink transmission to a third wireless device using a candidate resource selected from the set of candidate resources for the second RAT.

2. The method of claim 1, wherein the set of candidate resources are determined based on whether a transmission of the first wireless device can overlap with resources used by the first RAT.

3. The method of claim 2, further comprising:
determining that the first wireless device does not need to receive a third sidelink transmission scheduled in the set of resources;
determining that resources of the set of candidate resources can overlap resources of the third sidelink transmission based on the determination that the first wireless device does not need to receive the third sidelink transmission; and
scheduling a transmission, by the first wireless device, on a resource which overlaps the resources of the third sidelink transmission.

4. The method of claim 1, further comprising:
determining to receive a third sidelink transmission scheduled in the set of resources used by the first RAT;
determining that a transmission of the first wireless device cannot overlap the scheduled third sidelink transmission based on the determination to receive the third sidelink transmission; and
refraining from scheduling a transmission, by the first wireless device, during the third sidelink transmission.

5. The method of claim 1, further comprising:
converting the set of resources used by the first RAT to a corresponding set of resources in the second RAT;
determining a set of common resources based on the corresponding set of resources; and
determining the set of candidate resources for the second RAT based on the set of common resources.

6. The method of claim 2, further comprising:
determining a first sensing configuration for the second RAT, and
sensing a wireless medium based on the first sensing configuration for the second RAT.

7. The method of claim 6, further comprising sensing the set of common resources based on the sensing configuration for the second RAT.

8. The method of claim 6, further comprising:
determining that full sensing is configured for the first RAT;
determining that partial sensing is configured for the second RAT; and
sensing the set of common resources using full sensing.

9. (canceled)

10. (canceled)

11. (canceled)

12. (canceled)

13. (canceled)

14. (canceled)

15. (canceled)

16. (canceled)

17. (canceled)

18. A first wireless device comprising:
a radio; and
a memory;
a processor coupled to the radio and the memory,
wherein the processor is configured to, when executing instructions stored in the memory, cause the first wireless device to:
receive sidelink control information (SCI) of a first sidelink transmission from a second wireless device over a first radio access technology (RAT), the SCI indicating a set of resources used by the first RAT;
determine, based on the received sidelink transmission, a set of candidate resources for a second RAT from a sidelink resources pool for the second RAT, the second RAT different from the first RAT; and
transmit a second sidelink transmission to a third wireless device using a candidate resource selected from the set of candidate resources for the second RAT.

19. The wireless device of claim 18, wherein the set of candidate resources are determined based on whether a transmission of the first wireless device can overlap with resources used by the first RAT.

20. The wireless device of claim 19, wherein the processor is further configured to:
determine that the first wireless device does not need to receive a third sidelink transmission scheduled in the set of resources;
determine that resources of the set of candidate resources can overlap resources of the third sidelink transmission based on the determination that the first wireless device does not need to receive the third sidelink transmission; and
schedule a transmission, by the first wireless device, on a resource which overlaps the resources of the third sidelink transmission.

21. The wireless device of claim 18, wherein the processor is further configured to:
determine to receive a third sidelink transmission scheduled in the set of resources used by the first RAT;
determine that a transmission of the first wireless device cannot overlap the scheduled third sidelink transmission based on the determination to receive the third sidelink transmission; and
refrain from scheduling a transmission, by the first wireless device, during the third sidelink transmission.

22. The wireless device of claim 18, wherein the processor is further configured to:
convert the set of resources used by the first RAT to a corresponding set of resources in the second RAT;
determine a set of common resources based on the corresponding set of resources; and
determine the set of candidate resources for the second RAT based on the set of common resources.

23. The wireless device of claim 19, wherein the processor is further configured to:
determine a first sensing configuration for the second RAT, and
sense a wireless medium based on the first sensing configuration for the second RAT.

24. The wireless device of claim 23, wherein the processor is further configured to sense the set of common resources based on the sensing configuration for the second RAT.

25. The wireless device of claim 23, wherein the processor is further configured to:
determine that full sensing is configured for the first RAT;
determine that partial sensing is configured for the second RAT; and
sense the set of common resources using full sensing.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. An integrated circuit, configured to cause a first wireless device to:
receive sidelink control information (SCI) of a first sidelink transmission from a second wireless device over a first radio access technology (RAT), the SCI indicating a set of resources used by the first RAT;
determine, based on the received sidelink transmission, a set of candidate resources for a second RAT from a sidelink resources pool for the second RAT, wherein the second RAT is different from the first RAT; and
transmit a second sidelink transmission to a third wireless device using a candidate resource selected from the set of candidate resources for the second RAT.

42. The integrated circuit of claim 41, wherein the set of candidate resources are determined based on whether a transmission of the first wireless device can overlap with resources used by the first RAT.

43. The integrated circuit of claim 42, wherein the first wireless device is further configured to:
determine that the first wireless device does not need to receive a third sidelink transmission scheduled in the set of resources;
determine that resources of the set of candidate resources can overlap resources of the third sidelink transmission based on the determination that the first wireless device does not need to receive the third sidelink transmission; and
schedule a transmission, by the first wireless device, on a resource which overlaps the resources of the third sidelink transmission.

44. The integrated circuit of claim 41, wherein the first wireless device is further configured to:
determine to receive a third sidelink transmission scheduled in the set of resources used by the first RAT;
determine that a transmission of the first wireless device cannot overlap the scheduled third sidelink transmission based on the determination to receive the third sidelink transmission; and
refrain from scheduling a transmission, by the first wireless device, during the third sidelink transmission.
